(19) United States
(12) Patent Application Publication
(10) Pub. No.: US 2017/0181577 A1
(43) Pub. Date: Jun. 29, 2017

(54) MULTILAYER ROASTING FURNACE

(71) Applicant: Annie Chang, (US)

(72) Inventor: Chiou-Fu Chang, TAICHUNG CITY (TW)

(21) Appl. No.: 15/131,577

(22) Filed: Apr. 18, 2016

(30) Foreign Application Priority Data
Dec. 25, 2015 (TW) 104220844

(51) Int. Cl. A47J 37/07; A47J 37/06

(52) U.S. Cl. CPC A47J 37/0704; A47J 37/067

(57) ABSTRACT

A multilayer roasting furnace includes a support rack, a furnace, at least two roasting apparatuses, and a lid. The furnace is disposed on the support rack to have a predetermined distance from the ground. Air is able to enter the furnace from a bottom thereof. Each roasting apparatus includes a main body and a roasting net. The main body is hollow. The roasting net is arranged in the main body and is positioned on an inner wall of the main body. The main bodies of the roasting apparatuses are stacked to form a roasting space vertically and are placed on the furnace. A central portion of the roasting net of the roasting apparatus is disposed with a charcoal collecting cylinder. The charcoal collecting cylinder is hollow and is perforated on the side wall thereof. The lid is disposed on and covers the top roasting apparatus.

### BACKGROUND OF THE INVENTION

Field of the Invention

The present invention relates to a roasting furnace, more especially to a multilayer roasting furnace.

Description of the Prior Art

Generally speaking, meat or seafood needs little time to be roasted, so turning over the meat or seafood is not quite difficult to a user. However, some foods such as sweet potatoes need more time to be fully roasted, so the foods have to be turned over for several times to make the foods be heated evenly.

Besides, conventional roasting furnaces are designed to have single-layer structures, so the amount of food to be received therein is quite limited. In addition, the food may be burned when the fire is too close or be heated insufficiently when the fire is too distant.

### SUMMARY OF THE INVENTION

The main object of the present invention is to provide a multilayer roasting furnace which is able to roast food evenly, to reduce the loss of heat, and to prevent from scalding.

To achieve the above and other objects, a multilayer roasting furnace of the present invention includes a support rack, a furnace, at least two roasting apparatuses, and a lid.

The furnace is disposed on the support rack to have a predetermined distance from a ground. Air is able to enter the furnace from a bottom of the furnace. Each roasting apparatus includes a main body and a roasting net. The main body is hollow vertically. The roasting net is arranged in the main body and is positioned on an inner wall of the main body. The main bodies of the at least two roasting apparatuses are stacked to form a roasting space vertically and are placed on the furnace. A central portion of the roasting net of at least one of the roasting apparatuses is disposed with a charcoal collecting cylinder. The charcoal collecting cylinder is hollow vertically and is perforated on a side wall thereof. The lid is disposed on and covering the top one of the roasting apparatuses.

Thereby, the charcoal collecting cylinder may improve the performance of heating due to the stack effect. Thus, the food to be roasted has no need to be turned over or plural times. In addition, the heat can be utilized effectively.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of the present invention;

FIG. 2 is a breakdown drawing of the present invention;

FIGS. 3 and 4 are partial breakdown drawings of the present invention;

FIG. 5 is a profile of the present invention;

FIG. 6 is an illustration showing a first embodiment of the present invention;

FIG. 7 is an illustration showing a second embodiment of the present invention;

FIG. 8 is a breakdown drawing of a thermal insulation structure of the present invention;

FIGS. 9 and 10 are illustration of a thermal insulation structure of the present invention.

### DETAILED DESCRIPTION OF THE PREFERRED EMBODIMENTS

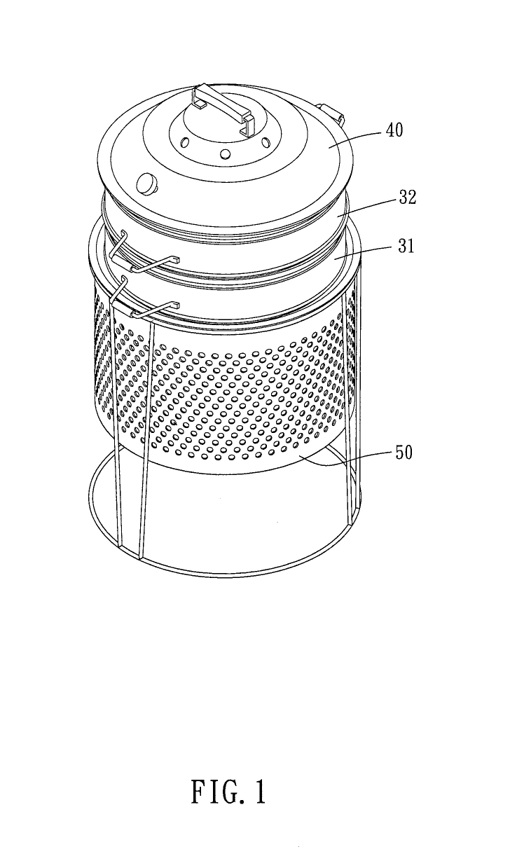

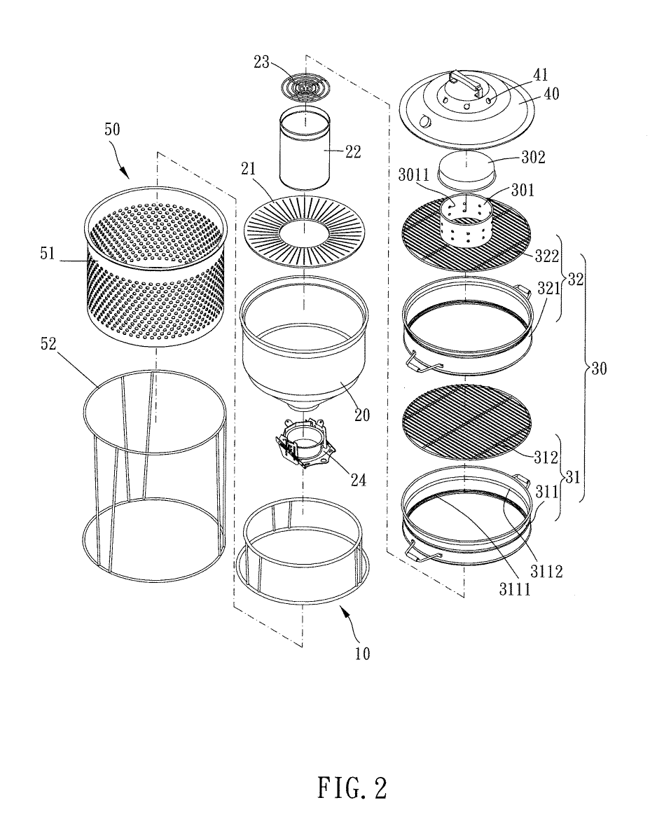

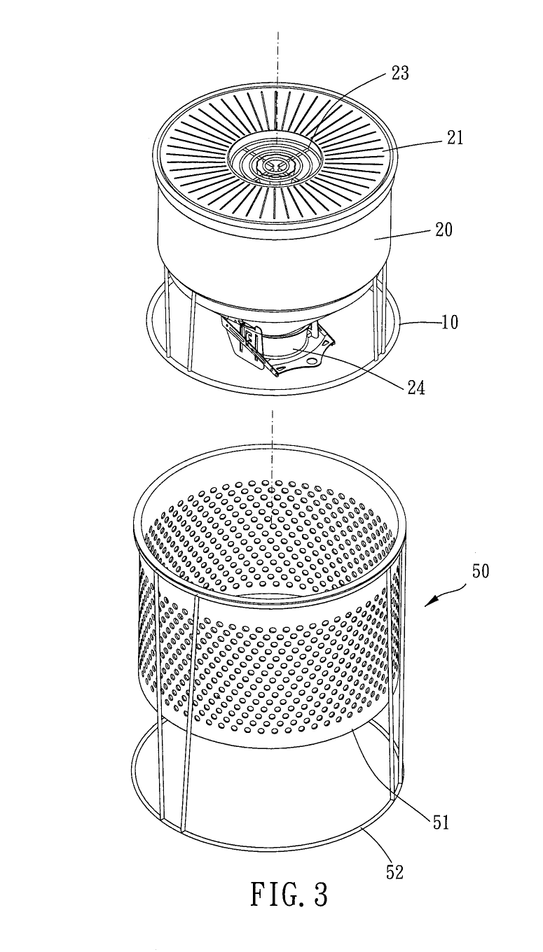

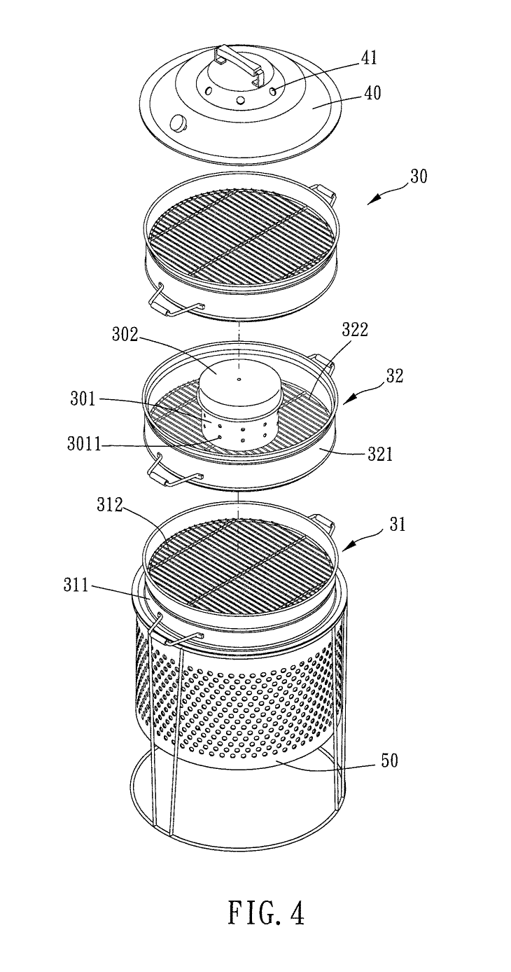

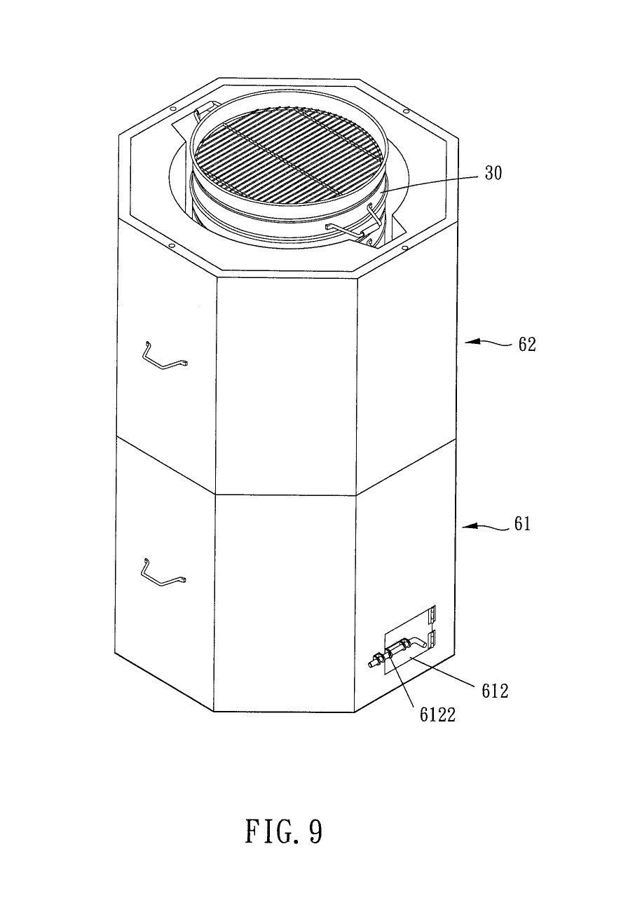

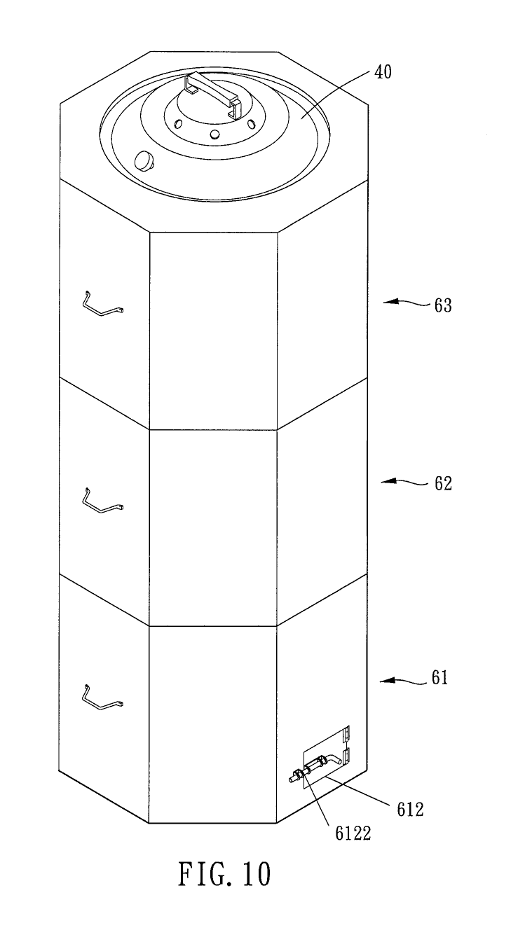

Please refer to FIG. 1 to FIG. 10, the multilayer roasting furnace of the present invention includes a support rack 10, a furnace 20, at least two roasting apparatuses 30,31,32, and a lid 40.

The furnace 20 is disposed on the support rack 10 and has a predetermined distance from the ground so that air can enter the furnace 20 via the bottom thereof. Each roasting apparatus 30,31,32 includes a main body 311,321 and a roasting net 312,322. The main body 311,321 is hollow along the vertical direction and has two handles at the periphery thereof for holding. The roasting net 312,322 is arranged in the main body 311,321 and is positioned on the inner wall of the main body 311,321. The main bodies 311,321 are stacked together to enclose a roasting space and are disposed on the furnace 20. The central portion of the top face of the roasting net 322 of at least one of the roasting apparatuses 32 is disposed with a charcoal collecting cylinder 301 which is hollow along the vertical direction. The side wall of the charcoal collecting cylinder 301 is perforated. The lid 40 is disposed on and covers the top one of the roasting apparatuses 30,31,32.

In the present embodiment, the support rack 10 comprises two round frames and plural support frames. The two round frames are arranged separately, and the support frames are arranged spacedly between the two round frames to connect them. The furnace 20 has a flange on the outer wall thereof to abut against the top one of the round frames. The furnace 20 has an upper portion which is cylinder-shaped and a lower portion which is funnel-shaped and is tapered downward. A bottom plate 21, a cylinder 22, and a charcoal net 23 are arranged in the furnace 20. The bottom plate 21 is located between the upper portion and the lower portion of the furnace 20. The bottom plate 21 is disk-shaped and hollow. The cylinder 22 is inserted through the bottom plate 21 and is placed on the inner wall of the upper portion of the furnace 20. Preferably, the cylinder 22 extends to the bottom of the furnace 20 so that air can only enter the cylinder 22 to be guided into the charcoal collecting cylinder. The charcoal net 23 is disposed on the top of the cylinder 22. The main body 311 of each roasting apparatus 30,31,32 has at least two support portions 3111,3112 on the inner wall thereof. The distances from the support portions 3111,3112 to the ground, or the heights of the support portions 3111,3112, vary so that the roasting net 312 can be selectively placed on one of the support portions 3111,3112. For example, the support portions 3111,3112 can be a groove and a flange respectively, and the roasting net 312 can be selectively received in the groove or be placed on the flange. Thereby, the user can adjust the position of the roasting net based on what kind of food is to be roasted. Besides, the lid 40 is formed with plural exhausting holes 41. Optionally, at least one cover 302 is included. The cover 302 is selectively disposed on the top of the charcoal collecting cylinder 301 to cover it so as to block the heat from going upward. Thereby, the upper roasting apparatuses may not be over-heated.

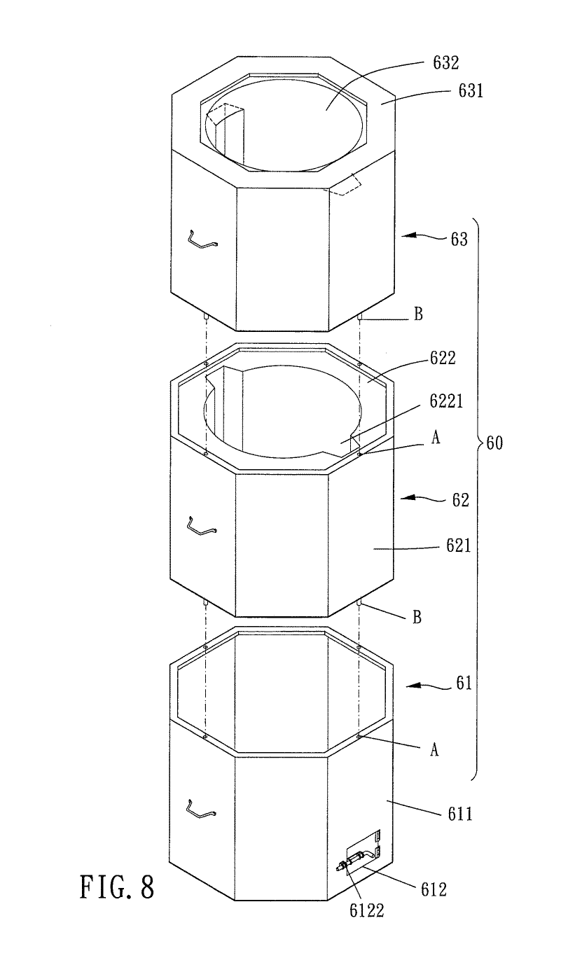

More specifically, the present embodiment includes at least three roasting apparatuses 30,31,32. The roasting net 322 of the roasting apparatuses except the bottom one 31 has the charcoal collecting cylinder 301. The charcoal collecting cylinders 301 are stacked and connected to form an elongated space. Optionally, an anti-scald shield 50, a fire regulation device 24, and a thermal insulation structure 60 are also included. The anti-scald shield 50 includes a shield 51 and a stand 52. The shield 51 is hollow along the vertical direction. The shield 51 is disposed on the stand 52 to have a predetermined distance from the ground. The shield 51 is formed with a plurality of holes for heat-dissipation. The support rack 10 stands on the inner wall of the shield 51 so that the furnace 20 is separated from the shield 51. The fire regulation device 24 is placed below the furnace 20. Preferably, the base plate 21 is inclined downward toward the central portion thereof, and the fire regulation device 24 includes a container to receive the oil or the broth from the roasted food dripping from the base plate 21. The container can also receive the falling charcoal dust. Further refer to FIGS. 8 to 10, the thermal insulation structure 60 includes a plurality of insulation members 61,62,63 covering the support rack, the furnace 20, and the roasting apparatuses 30,31,32. At least the insulation members 62,63 positionally corresponding to the roasting apparatuses 30,31,32 include a shell 621,631 and an insulation body 622,632. The insulation body 622,632 is disposed on the inner wall of the shell 621,631 and is hollow for receiving the roasting apparatuses. In addition, the inner wall of the insulation body 622,632 is formed with receiving grooves 6221 to receive the handles. The top portion of the top shell 631 extends toward the center to block the heat from dissipation. Preferably, the shell 621,631 is made of metal, such as stainless steel, and the insulation body 622,632 can be made of phenolic resin or Styrofoam. The number of the insulation members is decided based on the number and height of the roasting apparatuses. Besides, the insulation members 61,62 can be formed with plural positioning holes A on the top thereof, and the insulation members 62,63 can be formed with plural positioning pins B on the bottom thereof to insert into the positioning holes A so that the insulation members can be stacked precisely. The bottom insulation member 61 has no insulation body in the present embodiment. The insulation member 61 has a door 612 near the bottom thereof. When the door 612 is opened, the user can make some adjustment with the fire regulation device 24. When the door is closed, the door can be locked to the shell 611 by a lock 6122.

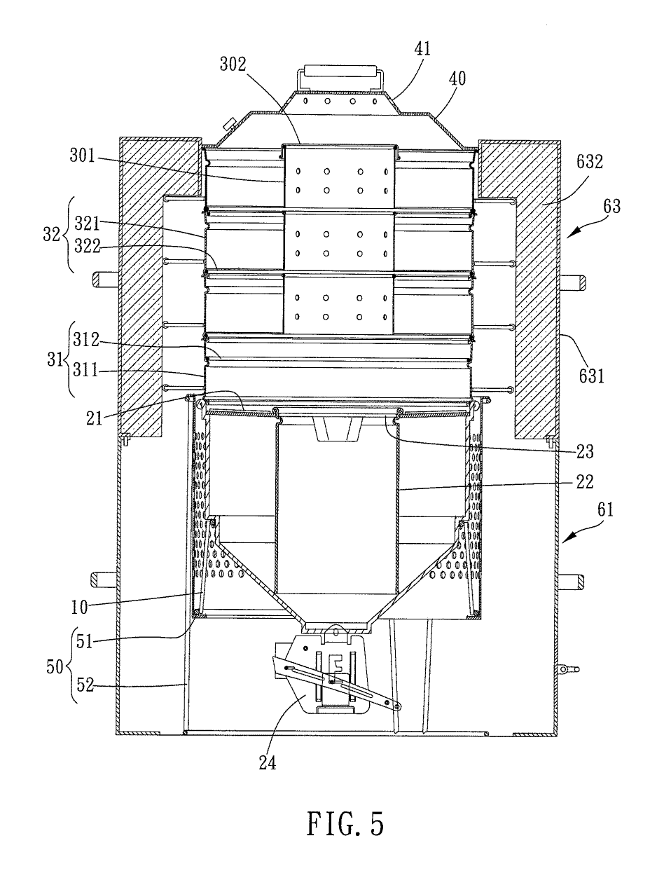

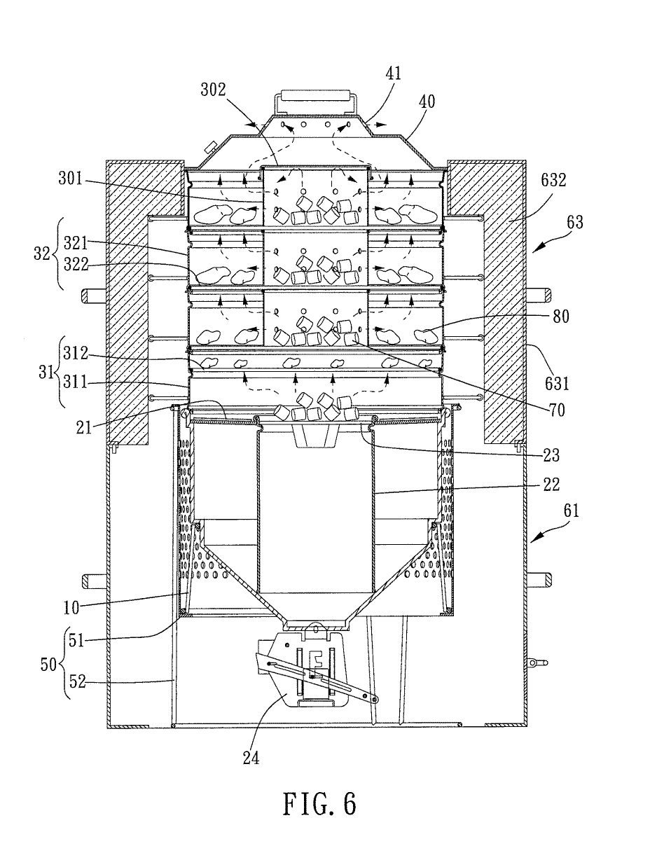

The arrangement and number of the roasting apparatuses can be alternated. For example, as shown in FIG. 5 and FIG. 6, the roasting net 312 of the bottom roasting apparatus 31 is positioned to the upper support portion 3112 to keep away from the charcoal net 23. In addition, the roasting apparatuses 32 except the bottom one 31 are disposed with the charcoal collecting cylinders 301 which receive the charcoal. The heat may go upward along the elongated space and spread to the food, such as sweet potatoes 80, on the roasting net 322 via the through holes 3011. The heat can further go upward via the roasting nets 322. Thus, the food can be heated evenly from various directions. The top one 301 of the charcoal collecting cylinder 301 is covered with the cover 302 to prevent the temperature of the top of the roasting furnace from becoming too high.

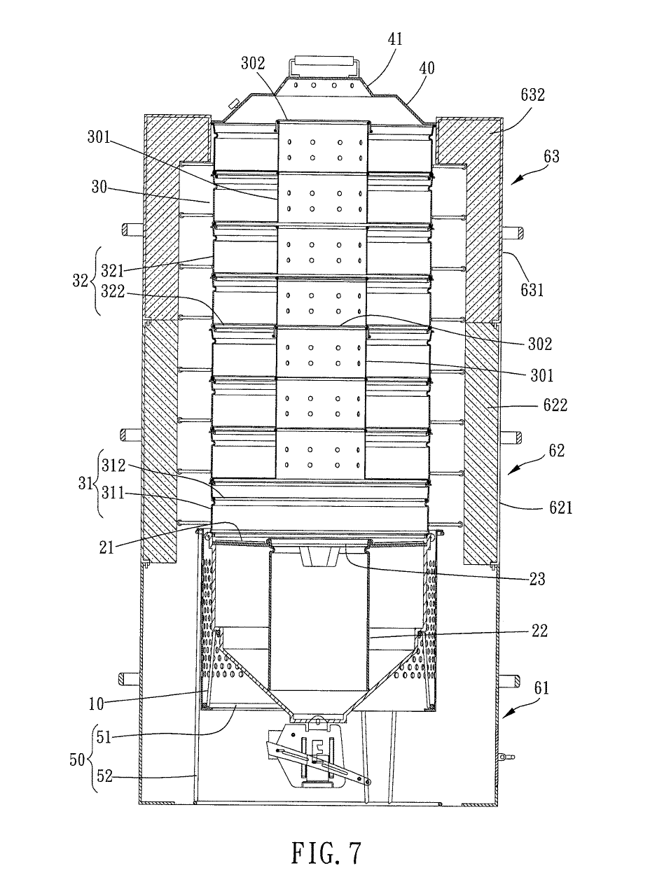

FIG. 7 shows an embodiment having more roasting apparatuses. However, the maximum number of the roasting apparatuses is preferably eight to prevent the stack effect too strong. Optionally, the charcoal collecting cylinder 301 at the intermediate section can be covered with the cover 302 to prevent the food on upper layers from being burned.

What is claimed is:

1. A multilayer roasting furnace, including;
a support rack;
a furnace, disposed on the support rack to have a predetermined distance from a ground, air being able to enter the furnace from a bottom of the furnace;
at least two roasting apparatuses, each roasting apparatus including a main body and a roasting net, the main body being hollow vertically, the roasting net being arranged in the main body and being positioned on an inner wall of the main body, the main bodies of the at least two roasting apparatuses being stacked to form a roasting space vertically and being placed on the furnace, a central portion of the roasting net of at least one of the roasting apparatuses being disposed with a charcoal collecting cylinder, the charcoal collecting cylinder being hollow vertically and being perforated on a side wall thereof;
a lid, disposed on and covering the top one of the roasting apparatuses.

2. The multilayer roasting furnace of claim 1, wherein the main body of each roasting apparatuses has at least two support portions on the inner wall thereof, distances from the support portions to a bottom of the roasting apparatus vary, the roasting net is selectively placed on one of the support portions.

3. The multilayer roasting furnace of claim 2, wherein at least one of the support portions is a groove to allow the roasting net to be selectively positioned therein, at least one of the support portions is a flange to allow the roasting net to be selectively placed thereon.

4. The multilayer roasting furnace of claim 1, further including an anti-scald shield, the anti-scald shield including a shield and a stand, the shield being hollow vertically, the shield being disposed on the stand to have a predetermined distance from the ground, the shield being formed with a plurality of holes for heat-dissipation, the support rack being positioned on an inner wall of the shield.

5. The multilayer roasting furnace of claim 1, further including a cover, the cover being selectively disposed on and covering a top of the charcoal collecting cylinder.

6. The multilayer roasting furnace of claim 1, wherein support rack includes two round frames and a plurality of support frames, the two round frames are arranged separately, the support frames are spacedly arranged between the round frames.

7. The multilayer roasting furnace of claim 1, further including a fire regulation device below the furnace.

8. The multilayer roasting furnace of claim 1, wherein an upper portion of the furnace is cylinder-shaped, a lower portion of the furnace is funnel-shaped and is tapered downward, a bottom plate, a cylinder, and a charcoal net are arranged in the furnace, the bottom plate is located between the cylinder-shaped upper portion and the funnel-shaped lower portion of the furnace, the bottom plate is hollow and disk-shaped, the cylinder is inserted through the bottom plate and is placed on an inner wall of the funnel-shaped lower portion of the furnace, the charcoal net is disposed on a top of the cylinder.

9. The multilayer roasting furnace of claim 1, further including a thermal insulation structure, the thermal insulation structure including at least one insulation member covering the support rack, the furnace, and the roasting apparatuses.

10. The multilayer roasting furnace of claim 9, wherein the thermal insulation structure includes a plurality of the insulation members, at least one of the insulation members, which positionally corresponds to the roasting apparatuses, comprises a shell and an insulation body, the insulation body is disposed on an inner wall of the shell.

11. The multilayer roasting furnace of claim 10, wherein the shell is made of metal, the insulation body is made of phenolic resin or Styrofoam.

12. The multilayer roasting furnace of claim 1, including at least three the roasting apparatuses, each of the roasting apparatuses except the bottom one has one the charcoal collecting cylinder, the charcoal collecting cylinders are stacked to form an elongated space.

13. The multilayer roasting furnace of claim 1, wherein the lid is formed with a plurality of exhausting holes.
